(19) United States
(12) Patent Application Publication
(10) Pub. No.: US 2026/0249798 A1
(43) Pub. Date: Aug. 27, 2026

(54) VEHICLE

(71) Applicant: KAWASAKI MOTORS, LTD., Hyogo (JP)

(72) Inventor: Yusuke NAKASHIMA, Akashi-shi (JP)

(73) Assignee: KAWASAKI MOTORS, LTD., Hyogo (JP)

(21) Appl. No.: 19/040,868

(22) Filed: Jan. 30, 2025

(51) Int. Cl. B60R 19/52; B60R 19/48; B62D 25/16

(52) U.S. Cl. CPC B60R 19/52; B62D 25/168; B60R 2019/486

(57) ABSTRACT

A vehicle includes: a front wheel; a vehicle body frame supporting the front wheel; a wheel housing accommodating the front wheel; a front cover located in a front portion of the vehicle; and a front guard including a guard portion located in front of the front cover, and a mounting part located behind the guard portion and mounted on the vehicle body frame. A region enclosed by the front cover, the front wheel, and the wheel housing overlaps the mounting part when viewed along a vehicle-width direction.

### TECHNICAL FIELD

This disclosure relates to a vehicle.

### SUMMARY

This vehicle includes: a front wheel; a vehicle body frame supporting the front wheel; a wheel housing accommodating the front wheel; a front cover located in a front portion of the vehicle; and a front guard including a guard portion located in front of the front cover, and a mounting part located behind the guard portion and mounted on the vehicle body frame, wherein a region enclosed by the front cover, the front wheel, and the wheel housing overlaps the mounting part when viewed along a vehicle-width direction.

The objects, features, aspects, and advantages of this disclosure will become more apparent from the following detailed description and the accompanying drawings.

### BRIEF DESCRIPTION OF DRAWINGS

FIG. 1 is a schematic side view illustrating a vehicle according to an embodiment.

FIG. 2 is a schematic side view illustrating a front portion of the vehicle.

FIG. 3 is a schematic perspective view illustrating the front portion of the vehicle.

FIG. 4 is a schematic front view illustrating the vehicle.

FIG. 5 is a schematic front view illustrating the vehicle without a front guard.

FIG. 6 is a schematic perspective view illustrating a front portion of the vehicle.

FIG. 7 is a schematic cross-sectional view taken along the VII-VII line in FIG. 4.

### DESCRIPTION OF THE PREFERRED EMBODIMENTS

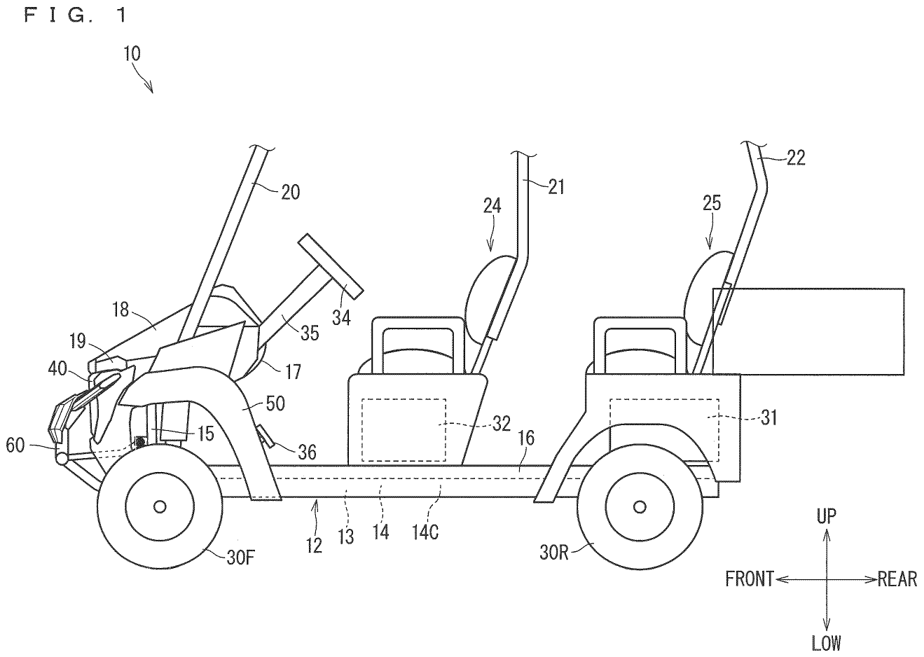

A vehicle according to an embodiment will be hereinafter described. FIG. 1 is a side view illustrating a vehicle 10. In the following description, a traveling direction of the vehicle 10 may be expressed as the front, the opposite direction may be expressed as the rear, a road surface side on which the vehicle 10 travels may be expressed as being low, and the opposite side may be expressed as being up. The right and left may be referred to while a person stands on a road surface and faces the front. A lateral direction is a vehicle-width direction. A side of a component refers to a position to the left or the right of the component.

The vehicle 10 may be a single-seater vehicle or a multi-seater vehicle. The vehicle 10 may have only a seat or seats in a forward and backward direction. Since the vehicle 10 is a vehicle designed to travel through, for example, private roads or private lands at low speeds, the vehicle 10 may have open right and left passenger entrances to seats without being obstructed by walls or doors to facilitate the occupant getting on or off the vehicle 10. Here, the occupant can walk past in the lateral direction without being obstructed by doors or walls.

### <Overall Structure of Vehicle>

The vehicle 10 includes a vehicle body 12 and a front guard 60. The vehicle 10 includes seats 24 and 25, a traveling mechanism, and a driving operation mechanism.

The vehicle body 12 may have a frame structure or a monocoque structure. This embodiment will be described assuming that the vehicle body 12 has a frame structure. The vehicle body 12 includes a vehicle body frame 13 and panels. The vehicle body frame 13 is structured by combining, for example, metallic pipe components, sheet metal components, or cast components. The panels cover the vehicle body frame 13 and various components supported by the vehicle body frame 13. The panels give the appearance of the vehicle 10, and partition spaces in the vehicle 10. Examples of the panels include a floor panel 16, a dashboard 17, a hood 18, a front cover 40, and wheel housings 50.

The floor panel 16 is disposed under the occupant space in which a driver and an occupant are located. The dashboard 17 is disposed in a front end of the occupant space. The dashboard 17 functions as a partition that separates the occupant space from a front internal space located in front of the occupant space. The dashboard 17 may include an instrument panel, a glove box, various switches, and an indicator. The hood 18 is located in front of the dashboard 17. The hood 18 functions as a partition that partitions above the front internal space.

The front cover 40 and the wheel housings 50 are disposed in a front portion of the vehicle 10. The front cover 40 and the wheel housings 50 give the appearances of the front surface and the side surfaces of the vehicle 10. The front cover 40 is disposed in a portion including a center of the vehicle 10. The pair of wheel housings 50 are disposed at both sides of the vehicle 10. The front cover 40 is located in a front lower portion of the hood 18. The pair of wheel housings 50 are located at both outside portions of the hood 18 in the lateral direction. The front cover 40 functions as a partition that partitions the front of the front internal space. The wheel housings 50 function as partitions that partition the sides of the front internal space.

The front guard 60 is a component that protects the vehicle body 12 from a front collision of the vehicle 10. The front guard 60 is also referred to as, for example, a brush guard or a grille guard. The front guard 60 is mounted in front of the front cover 40. The vehicle body frame 13 supports the front guard 60.

Each of the seats 24 and 25 is a part on which occupants are to be seated. The seats 24 and 25 are located on the floor panel 16. The vehicle body 12 supports the seats 24 and 25. The seats 24 and 25 are apart from each other in the forward and backward direction. The seat 24 is located in front of the seat 25. Each of the seats 24 and 25 includes a seat cushion, a back rest cushion, and a seat frame. The seat frames can be considered as parts of the vehicle body frame 13 in the vehicle body 12. Outside right and left portions of the seats 24 and 25 are openings through which the occupant gets on and off the vehicle 10. The vehicle 10 is intended to normally travel with the openings being opened and not closed by, for examples, doors.

The seats 24 and 25 are bench seats on which persons can be seated side by side in the vehicle-width direction. A driver seat on one side in the vehicle-width direction and a passenger seat on the other side in the vehicle-width direction are disposed to sandwich the middle in the vehicle-width direction. Here, a portion of the seat 24 on one side with respect to the middle in the vehicle-width direction is considered as the driver seat, and a portion of the seat 24 on the other side is considered as the passenger seat. The seat 24 may have a structure in which the driver seat and the passenger seat are independently provided.

The traveling mechanism is a mechanism for traveling of the vehicle 10, and includes wheels 30F and 30R, a traveling motor 31, and a power transmission mechanism. Transmission of rotation drive force of the traveling motor 31 to the wheels 30F and 30R through the power transmission mechanism allows the vehicle 10 to travel. This embodiment describes an example in which the vehicle 10 includes the four wheels 30F and 30R. The vehicle 10 may include three or six wheels. The structure of the power transmission mechanism is discretionary. Examples of the power transmission mechanism may include a transmission and a drive shaft.

The wheels 30F and 30R include the front wheels 30F and rear wheels 30R. The two front wheels 30F are supported to be rotatable around its own central axis and rotatable around a steering axis, at right and left front portions of the vehicle body 12. The two rear wheels 30R are supported to be rotatable around its own central axis at right and left rear portions of the vehicle body 12.

In this embodiment, the traveling motor 31 is an electric motor that converts electric energy into rotational motion for traveling. Here, the vehicle 10 includes a traveling battery 32 for supplying the electric energy to the traveling motor 31. For example, the traveling battery 32 is supported at a lower portion of the seat 24, and the traveling motor 31 is supported at a lower portion of the seat 25. The traveling motor 31 may be an internal combustion engine that burns fuel in a combustion chamber and generates power for traveling through expansion of gases from the burnt fuel. Here, the vehicle 10 should include a fuel tank. The positions of the traveling motor 31 and the traveling battery 32 are discretionary.

The driving operation mechanism is a mechanism for receiving a driving operation from the driver, and includes, for example, a steering wheel 34 and pedals 36. The operation of the steering wheel 34 by the driver enables the front wheels 30F to rotate around the steering axis. The driver can operate an accelerator and a brake through operations of the pedals 36. The steering wheel 34 and the pedals 36 are located in front of the seat 24. The driver seated on the seat 24 can operate the steering wheel 34 and the pedals 36. For example, a steering column 35 protrudes rearward from the dashboard 17, and the steering wheel 34 is supported at the end of the steering column 35. The pedals 36 are located below the steering wheel 34. The pedals 36 may be an accelerator pedal and a brake pedal that are separately provided. One pedal may operate both of the accelerator and the brake.

The vehicle 10 according to this embodiment includes headlights 19. The headlights 19 may be disposed, for example, between the hood 18 and the front cover 40 in the front portion of the vehicle 10.

The vehicle 10 according to this embodiment includes pillars. The pillars herein include front pillars 20, center pillars 21, and rear pillars 22. The front pillars 20 extend upward from both sides of the dashboard 17. The center pillars 21 extend upward from the back rest of the seat 24. The rear pillars 22 extend upward from behind the back rest of the seat 25. The upper ends of the pillars may be connected through cross portions. The center pillars 21 or the rear pillars 22 may extend from, for example, a floor portion except the seats 24 and 25. The number of the pillars is discretionary. For example, the center pillars 21 may be omitted.

A roof, which is not illustrated, may be supported at the top of the pillars. In this case, the vehicle 10 may include the roof. The roof spreads to cover the seats 24 and 25 from the top, above the seats 24 and 25. The roof has a function of providing the occupant with, for example, a sunshade and a weather shield. The roof may spread in the forward and backward direction from a position in front of the steering wheel 34 toward a position behind the back rest of the seat 25. The roof may spread to cover the whole of the seats 24 and 25 in the lateral direction.

### <Structure of Front Portion of Vehicle>

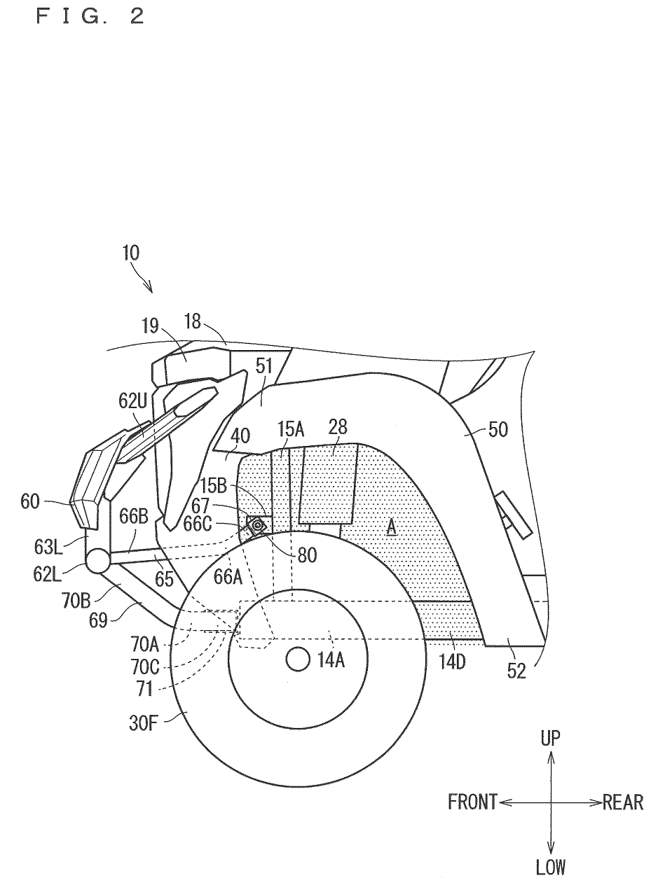

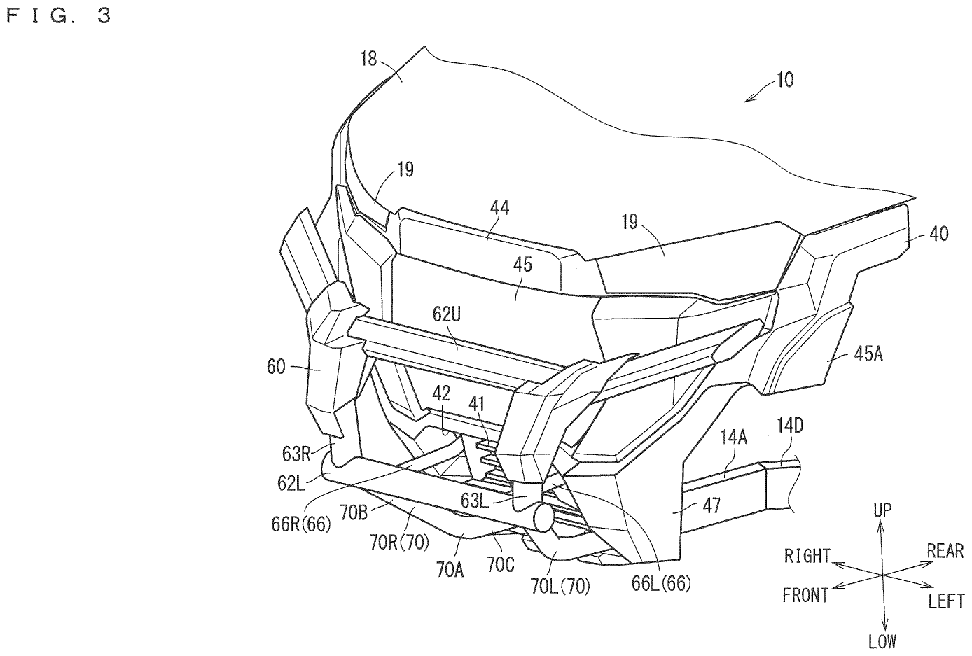

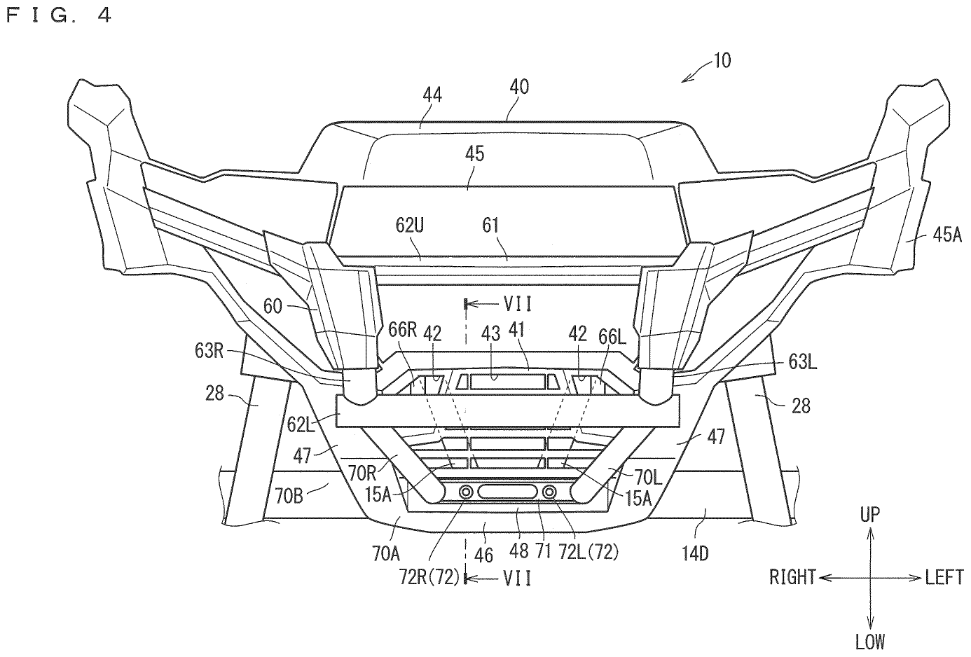

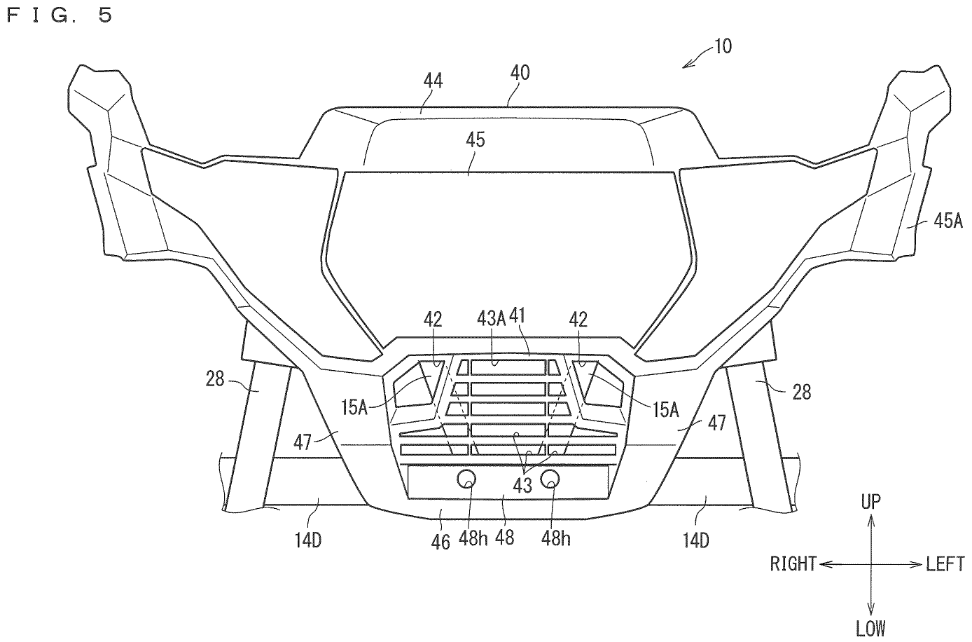

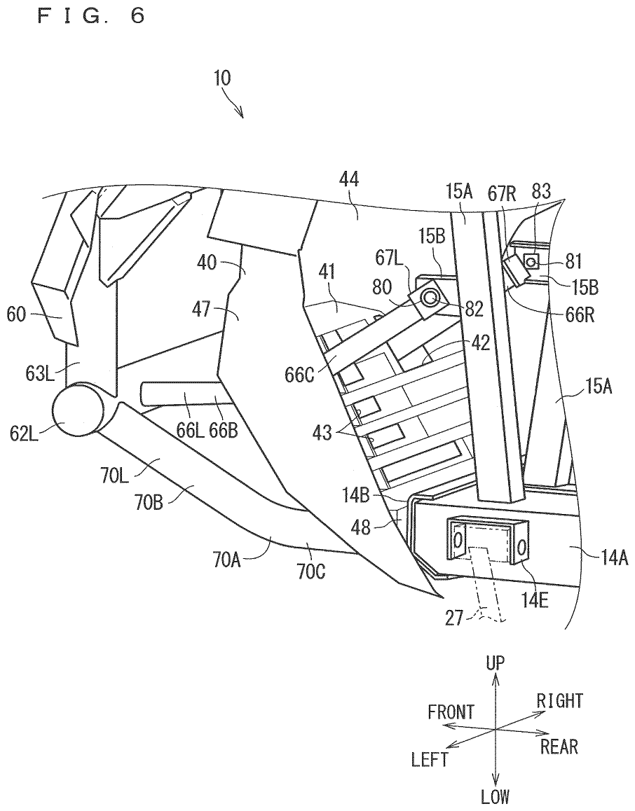

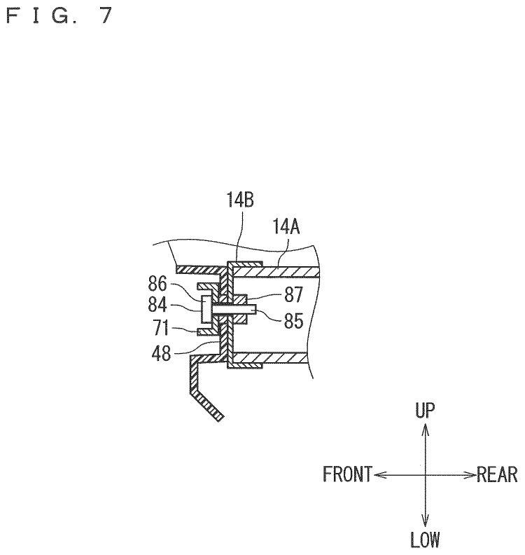

A structure of the front portion equipped with the front guard 60 in the vehicle 10 will be described in detail. FIG. 2 is a schematic side view illustrating the front portion of the vehicle 10. FIG. 3 is a schematic perspective view illustrating the front portion of the vehicle 10. FIG. 3 is a perspective view of the vehicle 10 when viewed from the front. FIG. 4 is a schematic front view illustrating the vehicle 10. FIG. 5 is a schematic front view illustrating the vehicle 10 without the front guard 60. FIG. 6 is a schematic perspective view illustrating the front portion of the vehicle 10. FIG. 6 is a perspective view of the vehicle 10 when viewed from the rear. FIG. 7 is a schematic cross-sectional view taken along the VII-VII line in FIG. 4.

The vehicle body frame 13 includes a bottom frame 14 and vertical frames 15.

The bottom frame 14 includes a floor constituent portion below the occupant space, and a front portion located in front of the floor constituent portion. The floor panel 16 is supported on the floor constituent portion.

The front portion includes right and left outside pipe frames 14A, and a coupling frame 14B that couples the right and left outside pipe frames 14A together. The right and left outside pipe frames 14A are disposed apart from each other along the vehicle-width direction. The right and left outside pipe frames 14A extend parallel in the forward and backward direction. The coupling frame 14B connects the front ends of the right and left outside pipe frames 14A.

The floor constituent portion also includes right and left outside pipe frames 14C. The right and left outside pipe frames 14C in the floor constituent portion are disposed apart from each other along the vehicle-width direction. The right and left outside pipe frames 14C extend parallel in the forward and backward direction, at positions outward of the right and left outside pipe frames 14A along the vehicle-width direction.

The right and left outside pipe frames 14C in the floor constituent portion have a spacing larger than that of the right and left outside pipe frames 14A in the front portion. The bottom frame 14 includes a coupling portion connecting the front portion to the floor constituent portion. The coupling portion also includes right and left outside pipe frames 14D. The outside pipe frames 14D in the coupling portion couple the outside pipe frames 14A in the front portion with the outside pipe frames 14C in the floor constituent portion. The outside pipe frames 14D in the coupling portion obliquely extend in the forward and backward direction. The outside pipe frames 14D in the coupling portion extend from the outside toward the inside in the vehicle-width direction, from the rear toward the front.

The vertical frames 15 extend upward from the bottom frame 14. Each of the vertical frames 15 includes a pipe frame 15A and a bracket 15B. A lower end of the pipe frame 15A is connected to the outside pipe frame 14A of the bottom frame 14. As illustrated in FIG. 6, the pipe frame 15A is connected to a position slightly behind the end of the outside pipe frame 14A. As illustrated in FIG. 4, the pipe frames 15A extend at the back side of a grille 41. The pipe frames 15A each extend from an inside toward an outside in the vehicle-width direction, from a lower portion toward an upper portion. The bracket 15B protrudes frontward from a middle portion of the pipe frame 15A in the vertical direction.

The bottom frame 14 supports the front wheels 30F. The front wheels 30F are located outward of the outside pipe frames 14A. For example, a knuckle arm 27 pivotably supports the outside pipe frame 14A in the vertical direction. As illustrated in FIG. 6, for example, a bracket 14E for supporting the knuckle arm 27 is disposed at an external side surface of the outside pipe frame 14A. The knuckle arm 27 extends downward from the outside pipe frame 14A toward the outside along the vehicle width. The front wheel 30F is supported at the end of the knuckle arm 27 to be rotatable around an axle. The axle of the front wheel 30F is located, for example, behind the vertical frame 15.

In this embodiment, the vehicle 10 includes front suspensions 28. For example, a lower end of the front suspension 28 is connected to the knuckle arm 27. An upper end of the front suspension 28 is connected to a portion of the vehicle body frame 13 which is located above the bottom frame 14. The front suspensions 28 are located, for example, behind the vertical frames 15.

The front cover 40 includes the grille 41 and a cover main body 44. The front cover 40 is made of, for example, a resin. The front cover 40 is a molded product obtained by, for example, injection molding or press working a plate. The front cover 40 may be of a single component or a combination of components. The front cover 40 has a bilaterally symmetrical shape with respect to the center in the lateral direction.

Holes 42 and 43 are formed in the grille 41. The holes 42 and 43 in the grille 41 penetrate the front cover 40 in the forward and backward direction. Here, the holes 42 and 43 include a pair of through holes 42 and grille holes 43. Here, the holes 42 and 43 are aligned up and down and at both sides. The pair of through holes 42 are disposed at a left upper position and a right upper position of the holes 42 and 43. Holes except the pair of through holes 42 in the holes 42 and 43 are the grille holes 43. The grille holes 43 are formed between and below the pair of through holes 42. The outer edge of the grille holes 43 extends in a grid pattern. In a part of grille holes 43A, a lateral dimension is larger than a vertical dimension. A vertical dimension of the through hole 42 is larger than a vertical dimension of the grille hole 43A. A difference between the vertical dimension and the lateral dimension of the through hole 42 is smaller than a difference between the vertical dimension and the lateral dimension of the grille hole 43A.

A component to be air-cooled may be disposed behind the grille 41. The component to be air-cooled is a heat generating component. The component to be air-cooled is a component preferably air-cooled by driving wind. Disposing the component to be air-cooled behind the grille 41 can air-cool the component to be air-cooled with the driving wind passing through the holes of the grille 41. The component to be air-cooled may be a component for dissipating heat of a travel driving unit. When the vehicle 10 is an electric vehicle, the component to be air-cooled may be a component for dissipating heat of the traveling battery 32. When the vehicle 10 is a vehicle with an internal combustion engine, the component to be air-cooled may be, for example, a radiator. The vehicle 10 may include a thermal conductive component that transmits heat of the travel driving unit to the component to be air-cooled.

The cover main body 44 is located adjacent to the grille 41 in a direction crossing the forward and backward direction. In this embodiment, the cover main body 44 is disposed to enclose the top and the bottom and both sides of the grille 41. The cover main body 44 includes an upper portion 45, a lower portion 46, and side portions 47. The upper portion 45 is a portion above the grille 41. The lower portion 46 is a portion below the grille 41. The side portions 47 are portions located at both sides of the grille 41.

The upper portion 45 is longer than the lower portion 46 in the vehicle-width direction. Lateral ends 45A of the upper portion 45 are connected to front ends 51 of the wheel housings 50. Lateral ends of the lower portion 46 are located outward of the front ends of the bottom frame 14 along the vehicle-width direction. The front wheels 30F are located outward of the lateral ends of the lower portion 46.

The lower portion 46 includes a frame connector 48. The frame connector 48 is, for example, connected to the front ends of the bottom frame 14 of the vehicle body frame 13. The frame connector 48 includes holes 48h. Here, the two holes 48h are formed. The two holes 48h are separated in the lateral direction. The two holes 48h penetrate the lower portion 46 along the forward and backward direction.

The wheel housings 50 are made of, for example, a resin. The wheel housings 50 are molded products each obtained by, for example, injection molding or press working a plate. A pair of the left and right wheel housings 50 are provided. The wheel housings 50 accommodate the front wheels 30F. The wheel housings 50 herein extend from the top toward the rear of the front wheels 30F. The front ends 51 of the wheel housings 50 are located above the front wheels 30F. Rear ends 52 of the wheel housings 50 are located behind the front wheels 30F.

The front guard 60 includes a guard portion 61, upper arm portions 65, upper mounting parts 67, a lower arm portion 69, and lower mounting parts 72.

The guard portion 61 is located in front of the front cover 40. The guard portion 61 is a portion that receives an impact in a collision. The guard portion 61 herein includes horizontal guard portions 62U and 62L, and vertical guard portions 63L and 63R.

The horizontal guard portions 62U and 62L are spaced from each other in the vertical direction. The horizontal guard portions 62U and 62L extend in the vehicle-width direction. The horizontal guard portion 62L is located below the horizontal guard portion 62U. The horizontal guard portion 62L is composed of a circular pipe. The horizontal guard portion 62U is composed of a square pipe. The horizontal guard portion 62U is longer than the horizontal guard portion 62L.

The vertical guard portions 63L and 63R are spaced from each other in the vehicle-width direction. The vertical guard portions 63L and 63R extend in the vertical direction. The vertical guard portions 63L and 63R couple the horizontal guard portions 62U and 62L together. The upper ends of the vertical guard portions 63L and 63R are connected to the horizontal guard portion 62U, and the lower ends of the vertical guard portions 63L and 63R are connected to the horizontal guard portion 62L. The vertical guard portions 63L and 63R and the horizontal guard portions 62U and 62L are connected to each other, for example, by welding or fastening. The vertical guard portions 63L and 63R are composed of circular pipes.

The upper arm portions 65 extend rearward from the guard portion 61. The upper arm portions 65 penetrate the front cover 40 in the forward and backward direction. The upper arm portions 65 herein penetrate the through holes 42 in the grille 41. Each of the upper arm portions 65 includes a middle portion fitted in the through hole 42, and a bent portion 66A located between the middle portion and a rear end. The rear end of the upper arm portion 65 is located above the middle portion. Here, the upper arm portions 65 include right and left first arms 66.

The right and left first arms 66 extend rearward from the horizontal guard portion 62L. Each of the right and left first arms 66 includes the bent portion 66A, and two straight portions 66B and 66C. The bent portion 66A is located between the two straight portions 66B and 66C. The bent portion 66A changes extension directions of the two straight portions 66B and 66C. The straight portions 66B extends rearward and upward from the horizontal guard portion 62L. A part of the straight portion 66B is disposed in the through hole 42. The bent portion 66A is located behind the through hole 42. The straight portion 66C extends rearward and upward from the bent portion 66A. The straight portion 66B is more horizontal than the straight portion 66C. The straight portion 66C is more vertical than the straight portion 66B. The first arm 66 is bent to form the bent portion 66A such that a rear portion of the bent portion 66A has an upward angle (an elevation angle) larger than that of a front portion of the bent portion 66A. The first arm 66 extends upward from the front end toward the rear end, and the upward angle (elevation angle) is changed at the bent portion 66A at some midpoint. The first arm 66 extends upward at a first elevation angle from the front end toward the bent portion 66A, and extends upward at a second elevation angle larger than the first elevation angle, from the bent portion 66A toward the rear end. The right and left first arms 66 are composed of, for example, circular pipes.

The upper mounting parts 67 are located behind the guard portion 61. The upper mounting parts 67 are located above the lower end of the front cover 40. The upper mounting parts 67 are mounted on the vehicle body frame 13. The upper mounting parts 67 are mounted on the brackets 15B of the vertical frames 15. The mounting direction of the upper mounting parts 67 is the vehicle-width direction. The upper mounting parts 67 are located at the rear ends of the upper arm portions 65. The upper mounting parts 67 include a first upper mounting part 67L located at the rear end of the first arm 66 L of the right and left first arms 66, and a second upper mounting part 67R located at the rear end of the other first arm 66R of the right and left first arms 66. The upper mounting part 67 is formed into an L-shaped plate. The upper mounting part 67 includes a first plate connected to an end of the first arm 66, and a second plate protruding rearward from an edge of the first plate. A mounting hole is formed in the second plate. The axis of the mounting hole in the upper mounting part 67 extends in the vehicle-width direction. The mounting hole of the upper mounting part 67 is a through hole penetrating the second plate in the vehicle-width direction.

The vehicle 10 includes mounting components 80. Each of the mounting components 80 mounts the upper mounting part 67 on the vehicle body frame 13. The mounting component 80 includes a mounting main body 81 and a head 82. The mounting main body 81 mounts the upper mounting part 67 on the vehicle body frame 13. The head 82 is a part for operating the mounting main body 81. An operator operates the head 82 in mounting the mounting component 80. The mounting components 80 are mounted from both sides. The head 82 is located outward of the mounting main body 81 in the vehicle-width direction. The mounting components 80 are, for example, bolts. The mounting main body 81 is a portion obtained by cutting threads from the bolt, and the head 82 is a bolt head. The mounting component 80 is fastened to a nut 83. The nut 83 is disposed in, for example, the bracket 15B of the vertical frame 15. The nut 83 may be fixed to the bracket 15B by, for example, welding.

The head 82 of the mounting component 80, the second plate of the upper mounting part 67, the bracket 15B, and the nut 83 overlap in this order from the outside in the vehicle-width direction. The mounting main body 81 of the mounting component 80 penetrates the second plate of the upper mounting part 67 and the bracket 15B, and is fastened to the nut 83.

The lower arm portion 69 includes right and left second arms 70 and a coupling arm 71. Each of the second arms 70 extends rearward from the guard portion 61, at a position lower than the right and left first arms 66. The coupling arm 71 couples the ends of the right and left second arms 70 together.

Each of the right and left second arms 70 includes a bent portion 70A, and two straight portions 70B and 70C. The bent portion 70A is located between the two straight portions 70B and 70C. The bent portion 70A changes extension directions of the two straight portions 70B and 70C. The straight portion 70B extends rearward and downward from the horizontal guard portion 62L. The straight portion 70B extends inward from the horizontal guard portion 62L in the vehicle-width direction. The straight portion 70C extends rearward from the bent portion 70A. The straight portions 70C are parallel in the forward and backward direction. The second arm 70 is bent to form the bent portion 70A such that the second arm 70 extending rearward and downward from the horizontal guard portion 62L and inward in the vehicle-width direction extends rearward along the forward and backward direction. The second arm 70 extends rearward and downward from the front end toward the bent portion 70A and inward in the vehicle-width direction, and extends rearward along the forward and backward direction from the bent portion 70A toward the rear end. The second arms 70 are composed of, for example, circular pipes. The second arms 70 are, for example, thicker than the first arms 66. The first arms 66 and the second arms 70 are thinner than the horizontal guard portion 62L.

The coupling arm 71 includes a main plate and protruding plates. The main plate spreads along the lateral direction and the vertical direction. The main plate is longer in the lateral direction than that in the vertical direction. The protruding plates protrude from the upper edge and the lower edge of the main plate. The ends of the second arms 70 are located between the upper protruding plate and the lower protruding plate, at the left end and the right end of the main plate.

The lower mounting parts 72 are located in front of the front cover 40. The lower mounting parts 72 are located above the lower end of the front cover 40. The lower mounting parts 72 are mounted on the vehicle body frame 13 below the upper mounting parts 67. The lower mounting parts 72 are mounted on the coupling frame 14B of the bottom frame 14. The mounting direction of the lower mounting parts 72 is the forward and backward direction. The lower mounting parts 72 are located at the lower arm portion 69. The lower mounting parts 72 include a first lower mounting part 72L and a second lower mounting part 72R that are located at separated portions of the coupling arm 71 in the vehicle-width direction. Holes formed in the main plate of the coupling arm 71 and its surrounding portion form the lower mounting parts 72.

The vehicle 10 includes mounting components 84. The mounting components 84 mount the lower mounting parts 72 on the vehicle body frame 13 together with the front cover 40. The lower mounting parts 72 are mounted on the vehicle body frame 13 via the mounting components 84 shared with the front cover 40. Each of the mounting components 84 includes a mounting main body 85 and a head 86. The mounting main body 85 mounts the lower mounting part 72 on the vehicle body frame 13. The head 86 is a part for operating the mounting main body 85. The operator operates the head 86 in mounting the mounting component 84. The mounting components 84 are mounted from the front. The head 86 is located in front of the mounting main body 85. The mounting components 84 are, for example, bolts. The mounting main body 85 is a portion obtained by cutting threads from the bolt, and the head 86 is a bolt head. For example, the mounting components 84 are fastened to nuts 87. The nuts 87 are disposed in a rear surface of the coupling frame 14B. The nuts 87 may be fixed to the coupling frame 14B by, for example, welding. The nuts 87 may be disposed inside the outside pipe frames 14A.

As illustrated in FIG. 7, the head 86 of the mounting component 84, the lower mounting part 72 (the coupling arm 71), the frame connector 48 of the front cover 40, the coupling frame 14B, and the nut 87 may overlap in this order from the front. In this case, the mounting main body 85 of the mounting component 84 penetrates the lower mounting part 72 (the coupling arm 71), the frame connector 48, and the coupling frame 14B, and is fastened to the nut 87. The holes 48h of the frame connector 48 may have collars made of a metal. These can prevent the front cover 40 made of a resin from being cracked when the mounting components 84 are fastened to the front cover 40.

The vehicle 10 has a region A enclosed by the front cover 40, the front wheel 30F, and the wheel housing 50 when viewed along the vehicle-width direction. The region A is a region indicated by dotted hatching in FIG. 2. The front of the region A is partitioned by, for example, a rear edge of a lower portion of the upper portion 45 of the front cover 40 and rear edges of the side portions 47. A lower portion of the region A is partitioned by, for example, an upper edge of the front wheel 30F. An upper portion of the region A is partitioned by, for example, a lower edge of the front end 51 of the wheel housing 50. A rear portion of the region A is partitioned by, for example, a front edge of the rear end 52 of the wheel housing 50.

The region A overlaps the upper mounting part 67 when viewed along the vehicle-width direction. The upper mounting part 67 is located in the region A when viewed along the vehicle-width direction. Here, the upper mounting part 67 is located closer to the front of the region A.

Parts except the upper mounting part 67 may be located in the region A when viewed along the vehicle-width direction. For example, a part of the vertical frame 15, a part of the front suspension 28, or a part of the bottom frame 14 may be located in the region A.

The upper mounting parts 67 are exposed in the vehicle-width direction. Here, for example, the second plates of the upper mounting parts 67, the rear ends of the first arms 66, and the heads 82 of the mounting components 80 are exposed in the vehicle-width direction. The bent portions 66A of the first arms 66 are hidden by the front cover 40 in the vehicle-width direction. The lower mounting parts 72 are hidden by the front cover 40 and the front wheels 30F in the vehicle-width direction. Here, the upper mounting part 67 is exposed in the vehicle-width direction in the region A. The upper mounting part 67 may be exposed in the vehicle-width direction in a position except the region A.

In the vehicle 10 with the aforementioned structure, the region A enclosed by the front cover 40, the front wheel 30F, and the wheel housing 50 overlaps the upper mounting part 67 when viewed along the vehicle-width direction. This facilitates access to the upper mounting part 67.

Furthermore, the upper mounting part 67 is located at the rear end of the upper arm portion 65. Thus, the upper mounting part 67 is easily installed behind the front guard 60.

Furthermore, since the first arms 66 penetrate the through holes 42 in the holes of the grille 41, the holes passing through the first arms 66 become unobtrusive in the front cover 40.

Furthermore, since the upper arm portions 65 include the bent portions 66A, when an impact is applied to the front guard 60, deformation of the bent portions 66A of the upper arm portions 65 can mitigate the impact on the vehicle body frame 13. Furthermore, since the rear ends of the upper arm portions 65 are located above the middle portions, the cover main body 44 can hide the upper mounting parts 67 from the front of the vehicle 10.

Furthermore, the front guard 60 includes the lower mounting parts 72 mounted on the vehicle body frame 13 below the upper mounting parts 67. Thus, the front guard 60 can be mounted on the vehicle body frame 13 at two portions along the vertical direction.

Each of the right and left first arms 66 includes the bent portion 66A, and each of the right and left second arms 70 includes the bent portion 70A. When an impact is applied to the front guard 60, deformation of the bent portions 66A and 70A of the arms 66 and 70 can mitigate the impact on the vehicle body frame 13.

The lower mounting parts 72 are mounted on the vehicle body frame 13 via the mounting components 84 shared with the front cover 40. This allows the front guard 60 and the front cover 40 to be simultaneously mounted. The portions on which the lower mounting parts 72 are mounted in the vehicle body frame 13 are also portions on which the front cover 40 is mounted. When the front guard 60 is an optional part and the front guard 60 is not mounted, the portions on which the lower mounting parts 72 are mounted in the vehicle body frame 13 do not become useless.

Furthermore, the head 86 of the mounting components 84 is located in front of the mounting main body 85 with respect to the lower mounting part 72 along the forward and backward direction. This facilitates access to the lower mounting part 72.

Furthermore, exposure of the upper mounting parts 67 in the vehicle-width direction facilitates access to the upper mounting parts 67.

### [Modifications]

Vehicles may be, for example, versatile small vehicles suitable for traveling through limited off-road areas rather than traveling through public roads at fast speeds. Off-road vehicles may be, for example, side-by-side vehicles. The side-by-side vehicles are, for example, small vehicles suitable for all terrain travel, particularly, off-road travel, and vehicles in which occupants can be seated side by side. The side-by-side vehicles may be, for example, multipurpose off-highway utility vehicles (MOHUVs) defined by ANSI/OPEI B71.9-2016, and recreational off-highway vehicles defined by ANSI/ROHVA 1-2016.

The vehicles may be passenger transport vehicles. The passenger transport vehicles are vehicles designed to travel at low speeds within a limited area. Examples of the limited area include limited community areas, and private roads and private lands (e.g., golf courses and parks) except public roads. The limited community areas may be areas provided for use by community residents. The community areas are, for example, areas including houses and public facilities (e.g., schools and hospitals), and are areas in which the passenger transport vehicles designed to travel through non-public highways are permitted to travel at low speeds. The low speeds are, for example, speeds with upper limits ranging from 20 mph to 30 mph. The passenger transport vehicles include personal transport vehicles (PTVs) in accordance with ANSI/ILTVA Z135, and golf carts in accordance with ANSI/ILTVA Z130.1. Furthermore, the passenger transport vehicles include personal transportation electric vehicles.

### [Appendixes]

This application discloses the following aspects.

A first aspect is a vehicle comprising: a front wheel; a vehicle body frame supporting the front wheel; a wheel housing accommodating the front wheel; a front cover located in a front portion of the vehicle; and a front guard including a guard portion located in front of the front cover, and a mounting part located behind the guard portion and mounted on the vehicle body frame, wherein a region enclosed by the front cover, the front wheel, and the wheel housing overlaps the mounting part when viewed along a vehicle-width direction.

This vehicle facilitates access to the mounting part.

A second aspect is the vehicle according to the first aspect, wherein the front guard includes an arm portion extending rearward from the guard portion and penetrating the front cover in a forward and backward direction, and the mounting part is located at a rear end of the arm portion.

Here, the mounting part is easily installed behind the front guard.

A third aspect is the vehicle according to the second aspect, wherein the front cover includes a grille with holes penetrating in the forward and backward direction, and a cover main body located adjacent to the grille in a direction crossing the forward and backward direction, and the arm portion penetrates a through hole in the holes.

Here, since the arm penetrates the through hole in the grille, the hole passing through the arm becomes unobtrusive.

A fourth aspect is the vehicle according to the third aspect, wherein the arm portion includes a middle portion fitted in the through hole, and a bent portion located between the middle portion and the rear end, the cover main body is located above the grille, and the rear end is located above the middle portion.

When an impact is applied to the front guard, deformation of the bent portion of the arm portion can mitigate the impact on the vehicle body frame. Furthermore, since the rear end is located above the middle portion, the cover main body can hide the mounting part from the front of the vehicle.

A fifth aspect is the vehicle according to any one of the first to fourth aspects, wherein the mounting part is located above a lower end of the front cover.

A sixth aspect is the vehicle according to any one of the first to fifth aspects, wherein the front guard includes a lower mounting part mounted on the vehicle body frame below the mounting part.

Thereby, the front guard can be mounted on the vehicle body frame at two portions in the vertical direction.

A seventh aspect is the vehicle according to the sixth aspect, wherein a mounting direction of the mounting part is the vehicle-width direction, and a mounting direction of the lower mounting part is a forward and backward direction.

An eighth aspect is the vehicle according to the sixth or the seventh aspect, wherein the vehicle body frame includes a bottom frame and a vertical frame extending upward from the bottom frame, the mounting part is mounted on the vertical frame, and the lower mounting part is mounted on the bottom frame.

A ninth aspect is the vehicle according to any one of the sixth to eighth aspects, wherein the front guard includes an upper arm portion including a first arm extending rearward from the guard portion, and a lower arm portion including a second arm extending rearward from the guard portion at a position lower than the first arm, the mounting part is located at a rear end of the upper arm portion, the lower mounting part is located at a rear end of the lower arm portion, and the first arm includes a bent portion, and the second arm includes a bent portion.

When an impact is applied to the front guard, deformation of the bent portion of each of the arm portions can mitigate the impact on the vehicle body frame.

A tenth aspect is the vehicle according to any one of the sixth to ninth aspects, wherein the front guard includes: an upper arm portion including right and left first arms extending rearward from the guard portion; and a lower arm portion including right and left second arms extending rearward from the guard portion at positions lower than the right and left first arms, and a coupling arm coupling rear ends of the right and left second arms together, the mounting part includes a first upper mounting part located at a rear end of one of the right and left first arms, and a second upper mounting part located at a rear end of the other of the right and left first arms, and the lower mounting part includes a first lower mounting part and a second lower mounting part that are located at separated portions of the coupling arm in the vehicle-width direction.

An eleventh aspect is the vehicle according to any one of the sixth to tenth aspects, wherein the lower mounting part is located above a lower end of the front cover.

A twelfth aspect is the vehicle according to any one of the sixth to eleventh aspects, the vehicle comprising a mounting component mounting the lower mounting part on the vehicle body frame together with the front cover.

This allows the front guard and the front cover to be simultaneously mounted. The portion on which the lower mounting part is mounted in the vehicle body frame is also a portion on which the front cover is mounted. When the front guard is an optional part and the front guard is not mounted, the portion on which the lower mounting part is mounted in the vehicle body frame does not become useless.

A thirteenth aspect is the vehicle according to any one of the sixth to twelfth aspects, wherein the lower mounting part is located in front of the front cover.

A fourteenth aspect is a vehicle comprising: a vehicle body frame; a front cover located in a front portion of the vehicle; a front guard including a guard portion located in front of the front cover, and a mounting part mounted on the vehicle body frame; and a mounting component including a mounting main body mounting the mounting part on the vehicle body frame, and a head for operating the mounting main body, wherein the head is located in front of the mounting main body along a forward and backward direction.

This facilitates access to the mounting part.

A fifteenth aspect is the vehicle according to the fourteenth aspect, wherein the vehicle body frame includes a bottom frame, and the mounting part is mounted on the bottom frame.

A sixteenth aspect is the vehicle according to the fourteenth or the fifteenth aspect wherein the mounting part is located above a lower end of the front cover.

A seventeenth aspect is the vehicle according to any one of the fourteenth to sixteenth aspects, wherein the mounting component mounts the mounting part on the vehicle body frame together with the front cover.

This allows the front guard and the front cover to be simultaneously mounted. Furthermore, the portion on which the mounting part is mounted in the vehicle body frame is also a portion on which the front cover is mounted. When the front guard is an optional part and the front guard is not mounted, the portion on which the mounting part is mounted in the vehicle body frame does not become useless.

An eighteenth aspect is the vehicle according to any one of the fourteenth to seventeenth aspects, wherein the mounting part is located in front of the front cover.

A nineteenth aspect is the vehicle according to any one of the fourteenth to eighteenth aspects, wherein the front guard includes an arm portion extending rearward from the guard portion, the mounting part is located at a rear end of the arm portion, and the arm portion includes a bent portion.

When an impact is applied to the front guard, deformation of the bent portion of the arm portion can mitigate the impact on the vehicle body frame.

A twentieth aspect is a vehicle comprising: a vehicle body frame; a front cover located in a front portion of the vehicle; and a front guard including a guard portion located in front of the front cover, and a mounting part located behind the guard portion and mounted on the vehicle body frame, wherein the mounting part is exposed in a vehicle-width direction.

This facilitates access to the mounting part.

The foregoing description is in all aspects illustrative and does not restrict this invention. Numerous modifications and variations that have not yet been exemplified are devised without departing from the scope of this invention.

What is claimed is:

1. A vehicle, comprising:
a front wheel;
a vehicle body frame supporting the front wheel;
a wheel housing accommodating the front wheel;
a front cover located in a front portion of the vehicle; and
a front guard including a guard portion located in front of the front cover, and a mounting part located behind the guard portion and mounted on the vehicle body frame,
wherein a region enclosed by the front cover, the front wheel, and the wheel housing overlaps the mounting part when viewed along a vehicle-width direction.

2. The vehicle according to claim 1,
wherein the front guard includes an arm portion extending rearward from the guard portion and penetrating the front cover in a forward and backward direction, and
the mounting part is located at a rear end of the arm portion.

3. The vehicle according to claim 2,
wherein the front cover includes a grille with holes penetrating in the forward and backward direction, and a cover main body located adjacent to the grille in a direction crossing the forward and backward direction, and
the arm portion penetrates a through hole in the holes.

4. The vehicle according to claim 3,
wherein the arm portion includes a middle portion fitted in the through hole, and a bent portion located between the middle portion and the rear end,
the cover main body is located above the grille, and
the rear end is located above the middle portion.

5. The vehicle according to claim 1,
wherein the mounting part is located above a lower end of the front cover.

6. The vehicle according to claim 1,
wherein the front guard includes a lower mounting part mounted on the vehicle body frame below the mounting part.

7. The vehicle according to claim 6,
wherein a mounting direction of the mounting part is the vehicle-width direction, and
a mounting direction of the lower mounting part is a forward and backward direction.

8. The vehicle according to claim 6,
wherein the vehicle body frame includes a bottom frame and a vertical frame extending upward from the bottom frame,
the mounting part is mounted on the vertical frame, and
the lower mounting part is mounted on the bottom frame.

9. The vehicle according to claim 6,
wherein the front guard includes an upper arm portion including a first arm extending rearward from the guard portion, and a lower arm portion including a second arm extending rearward from the guard portion at a position lower than the first arm,
the mounting part is located at a rear end of the upper arm portion,
the lower mounting part is located at a rear end of the lower arm portion, and
the first arm includes a bent portion, and the second arm includes a bent portion.

10. The vehicle according to claim 6,
wherein the front guard includes: an upper arm portion including right and left first arms extending rearward from the guard portion; and a lower arm portion including right and left second arms extending rearward from the guard portion at positions lower than the right and left first arms, and a coupling arm coupling rear ends of the right and left second arms together,
the mounting part includes a first upper mounting part located at a rear end of one of the right and left first arms, and a second upper mounting part located at a rear end of the other of the right and left first arms, and
the lower mounting part includes a first lower mounting part and a second lower mounting part that are located at separated portions of the coupling arm in the vehicle-width direction.

11. The vehicle according to claim 6,
wherein the lower mounting part is located above a lower end of the front cover.

12. The vehicle according to claim 6, comprising
a mounting component mounting the lower mounting part on the vehicle body frame together with the front cover.

13. The vehicle according to claim 6,
wherein the lower mounting part is located in front of the front cover.

14. A vehicle, comprising:
a vehicle body frame;
a front cover located in a front portion of the vehicle;
a front guard including a guard portion located in front of the front cover, and a mounting part mounted on the vehicle body frame; and
a mounting component including a mounting main body mounting the mounting part on the vehicle body frame, and a head for operating the mounting main body,
wherein the head is located in front of the mounting main body along a forward and backward direction.

15. The vehicle according to claim 14,
wherein the vehicle body frame includes a bottom frame, and
the mounting part is mounted on the bottom frame.

16. The vehicle according to claim 14,
wherein the mounting part is located above a lower end of the front cover.

17. The vehicle according to claim 14,
wherein the mounting component mounts the mounting part on the vehicle body frame together with the front cover.

18. The vehicle according to claim 14,
wherein the mounting part is located in front of the front cover.

19. The vehicle according to claim 14,
wherein the front guard includes an arm portion extending rearward from the guard portion,
the mounting part is located at a rear end of the arm portion, and
the arm portion includes a bent portion.

20. A vehicle, comprising:
a vehicle body frame;
a front cover located in a front portion of the vehicle; and
a front guard including a guard portion located in front of the front cover, and a mounting part located behind the guard portion and mounted on the vehicle body frame,
wherein the mounting part is exposed in a vehicle-width direction.
